(19) United States
(12) Patent Application Publication
(10) Pub. No.: US 2008/0180725 A1
(43) Pub. Date: Jul. 31, 2008

(54) User-defined cluster printing

(76) Inventor: Burton L. Levin, Lake Oswego, OR (US)

Correspondence Address: SHARP LABORATORIES OF AMERICA, INC.;C/O LAW OFFICE OF GERALD MALISZEWSKI, P.O. BOX 270829, SAN DIEGO, CA, 92198-2829, US

(21) Appl. No.: 11/698,596

(22) Filed: Jan. 26, 2007

(51) Int. Cl. G06F 3/12

(52) U.S. Cl. 358/1.15

(57) ABSTRACT

In a client terminal network connected to a plurality of printers, a system and method are provided for user-defined cluster printing. At a client terminal, the method involves user-selecting a cluster, where each cluster includes a plurality of printers network-connected to the client terminal. Then, the method creates a file set to be printed, where the file set includes a plurality of files. Software applications associated with each file in the file set are automatically opened and each file is converted into a printer-ready formatted document. Finally, the documents are automatically distributed to printers in the selected cluster for concurrent printing. Document finishing options can be selected by a user in response to automatically opening software applications associated with each file, and sent to the printers in the form of document processing instructions. Finishing options may be correlated to printer capabilities, and the documents distributed in response to correlation process.

### BACKGROUND OF THE INVENTION

1. Field of the Invention

This invention generally relates to digital document processing and, more particularly, to a system and method for generating user-defined printer cluster groups for the automatic distribution of documents for printing.

2. Description of the Related Art

In large corporate work environments occupying large amounts of office space, an employee typically has more than one printer available on the local network for printing their documents. The user may choose any of the available printers to print a multiplicity of documents concurrently. However, the user is required to manually select each document, open the document, choose a printer, and then send the document to the printer. If this is a frequently occurring task, it quickly becomes time consuming, tedious, and ultimately frustrating to the user.

Alternately, the user may manually select a printer for each document, by opening each document's native application, and printing each document separately. However, the disadvantages noted in the preceding paragraph still remain.

Another solution is to open a browser, move to a directory containing all the documents (files), highlight the documents to be printed, and choose the ‘print all’ option. The disadvantages of this method are that all the documents must be in the same folder, and that all the documents go to the same printer with the exact same printing and finishing options. This method also retains the disadvantages of the multi-step process mentioned above.

One solution is the use of cluster printing to automatically distribute the various documents to available printers in the clustered group. Typically, cluster printing is enabled using a server that is linked to a specific ‘cluster’ of printers. The user cannot add or delete printers from the predetermined cluster. Further, the files must be already formatted for printing, e.g., in a printer control language (PCL), portable document format (PDF), or the XML Paper specification (XPS) format, which is associated with MS Vista™. The disadvantages of cluster printing are that some of the printers in the cluster are likely to be inconveniently located. Also, the user must still either manually open each native application to convert the file into a printer-ready format, or open a browser to select documents in a common folder. As mentioned above, this browser selection method necessitates that the documents being printed with the same finishing options. Finally, the cluster automatic distribution algorithm may choose to separate the documents into logical parts that may have to be reassembled manually.

It would be advantageous if an automatic distribution process existed for concurrently printing a plurality of documents that permitted a user to manually select the printers in a cluster.

It would also be advantageous if a user could select different finishing options for the automatically distributed documents.

### SUMMARY OF THE INVENTION

The present invention describes a system and method that permits the user to partially automate the process of concurrently printing a set of documents, maintaining control over the print options and the selection of printers to be used. Advantageously, the user can choose a plurality of documents in different folders. The documents may be created by a diverse set of applications. Without opening any of the documents' native applications, the user can send a single request to print all documents concurrently to a user-selected set of printers. Optionally, job queuing and job distribution may be user selected, rather than defaulting to application print driver or other system services. In this manner, the invention simulates clustering, while permitting greater user control.

Accordingly, in a client terminal network connected to a plurality of printers, a method is provided for user-defined cluster printing. At a client terminal, the method involves user-selecting a cluster, where each cluster includes a plurality of printers network-connected to the client terminal. Then, the method creates a file set to be printed, where the file set includes a plurality of files. Software applications associated with each file in the file set (the native applications) are automatically opened and each file is converted into a printer-ready formatted document. Finally, the documents are automatically distributed to printers in the selected cluster for concurrent printing.

In one aspect, the file set is created by accessing a client terminal operating system (OS), and an OS browser is used to select files from a client terminal file system directory. Then, the OS calls the application that created the selected file (the native application) to perform the file conversion. Typically, files are converted into a printer-ready document format compatible with the printer to which the document is to be distributed.

In another aspect, document finishing options can be selected by a user in response to automatically opening software applications associated with each file, and sent to the printers in the form of document processing instructions. Further, the method may correlate finishing options to printer capabilities, and distribute documents to printers in response to correlation process.

Additional details of the above-described method, and a system for user-defined cluster printing in a client terminal network-connected to a plurality of printers are provided below.

### BRIEF DESCRIPTION OF THE DRAWINGS

FIG. 1 is a schematic block diagram of a client terminal network connected to a plurality of printers, with a system for user-defined cluster printing.

FIG. 2 is a diagram depicting the selection of files from an OS browser, and the selection of printers in the user-defined cluster.

FIG. 3 is a diagram depicting the selection of finishing options for each document.

FIG. 4 is a diagram depicting the automatic assignment of documents to printers.

FIG. 5 is a flowchart illustrating a method for user-defined cluster printing in a client terminal network connected to a plurality of printers.

### DETAILED DESCRIPTION

Various embodiments are now described with reference to the drawings. In the following description, for purposes of explanation, numerous specific details are set forth in order to provide a thorough understanding of one or more aspects. It may be evident, however, that such embodiment(s) may be practiced without these specific details. In other instances, well-known structures and devices are shown in block diagram form in order to facilitate describing these embodiments.

As used in this application, the terms “component,” “module,” “system,” and the like are intended to refer to a computer-related entity, either hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets (e.g., data from one component interacting with another component in a local system, distributed system, and/or across a network such as the Internet with other systems by way of the signal).

Various embodiments will be presented in terms of systems that may include a number of components, modules, and the like. It is to be understood and appreciated that the various systems may include additional components, modules, etc. and/or may not include all of the components, modules etc. discussed in connection with the figures. A combination of these approaches may also be used.

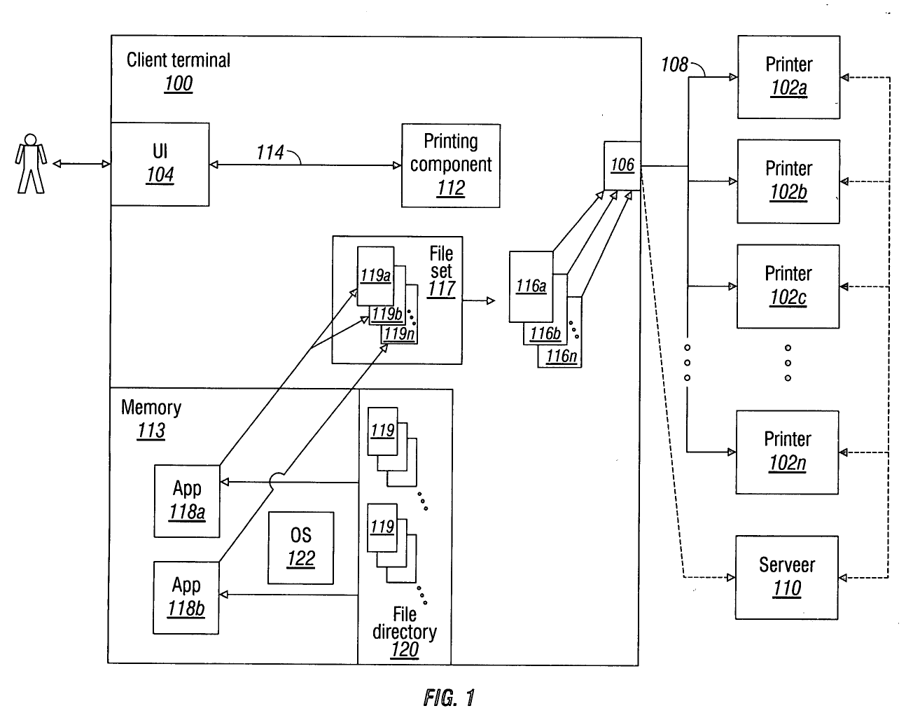

FIG. 1 is a schematic block diagram of a client terminal 100 network connected to a plurality of printers, with a system for user-defined cluster printing. Typically, the client terminal 100 is a personal computer (PC), but it may also be a portable handheld device such as a personal digital assistant (PDA) or cellular telephone, to name a few examples. Here, printers 102a, 102b, 102c, and 102n are shown, but it should be understood that the client terminal need not necessarily be connected to only four printers. As used herein, a printer is any peripheral device that prints on a physical medium such as paper. A printer may incorporate other functions, such as scanning, faxing, or copying.

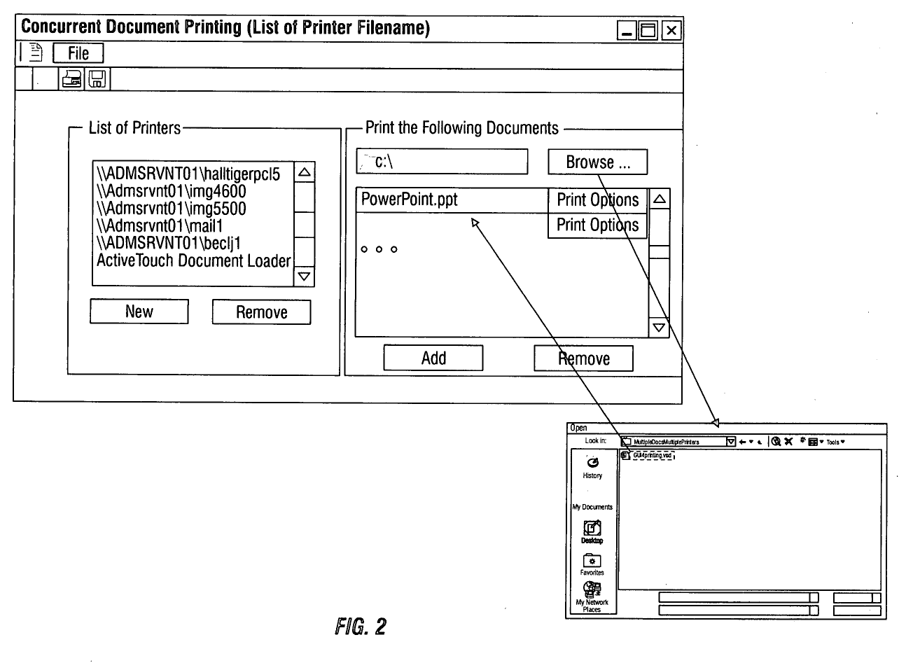

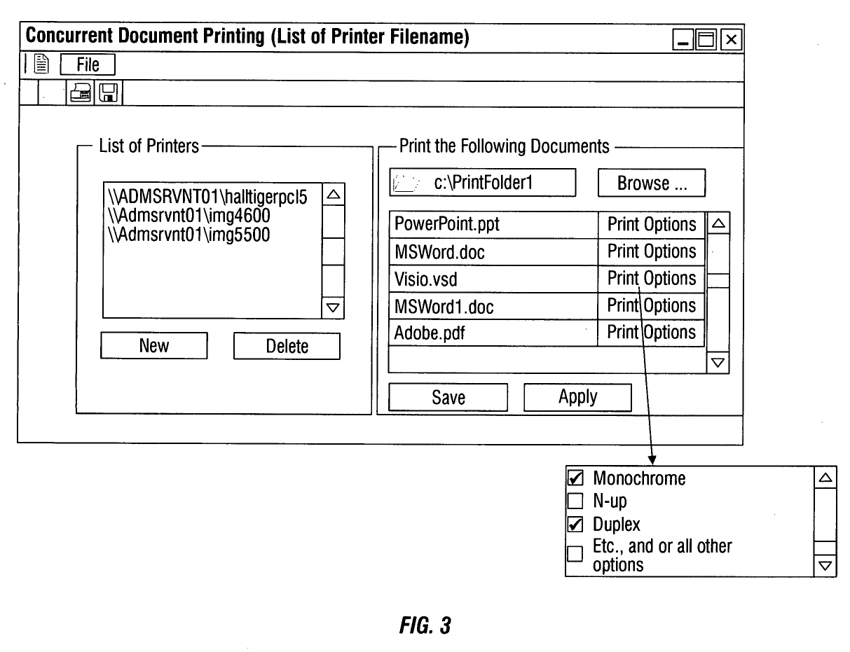

The client terminal 100 has a user interface (UI) 104. Typically, the UI 104 includes a display, keyboard, and/or mouse. However, the invention may be enabled with other types of UI (e.g., speech recognition and/or touchscreens). The UI is able to communicate (e.g., prompts) with a user and accept user instructions (e.g., prompt responses). For example, communications may be enabled with the use of a graphical user interface (GUI), see FIGS. 2 and 3. The client terminal 100 has a network interface 106 connected to the plurality of printers 102 on line 108, which may represent local, network, or a combination of local and network connections. The invention is not limited to any particular type of network, physical medium, or communication protocol. The network may be a LAN, WAN, or Internet, for example. The printers may be communicatively-coupled through a wired, wireless, or combination of connections. A local connection may be enabled with a USB, serial, or parallel port interface, for example. In some aspects, a server 110 may act as an interface between the client terminal 100 and the printers 102. Here, the communications between the client terminal 100, server 110, and printers 102 are depicted with dotted lines.

A user-defined cluster printing component 112 is stored as software coded instructions in a client terminal memory 113. The printing component 112 communicates with the UI 104 on line 114, typically in the form of prompts and user responses, to accept cluster selections, where each cluster includes a plurality of network-connected printers. For example, a user-selected cluster may include printers 102a, 102b, and 102c, but not 102n. The printing component 112 also accepts instructions for creating a file set 117 including a plurality of files 119 to be printed. The printing component automatically distributes documents 116 to printers 112 in the selected cluster, via the network interface 106, for concurrent printing.

The printing component 112 automatically initiates the opening of software applications 118 associated with each file 119 in the file set 117, to convert each file into a printer-ready formatted document 116. That is, the printing component 112 may open native applications 118, where it is understood that a “native” application is the application originally used to create a file. The application 118 converts the file 119 into a document 116. For example, application (app) 118a (e.g., Microsoft Word™) may have created files 119a and 119b, and application 118b (e.g., Adobe Acrobat™), may have created file 119n. In this example, file 119a has been converted to document 116a, file 119b has been converted to document 116b, and file 119n has been converted to document 116n. A document, as used herein, is a text or image file that is formatted in a printer-ready language, such as PDF, printer description language (PDL), or PCL, to name a few examples.

Typically, the client terminal 100 includes a file system represented as a directory 120 of files, and an operating system (OS) 122 of microprocessor instructions, both stored in memory 113. In one aspect, the printing component 112 accesses an OS browser to select files 119 from the file system directory 120, and the OS calls an application 118 that created the selected file to convert files into printer-ready formatted documents 116. Regardless of whether of the OS browser is used, or if the printing component 112 directly accesses the applications 118 using a custom software module, when a printer is selected (e.g., printer 102a) and a document (e.g., document 116a) is distributed to that printer 102a, the printing component 112 supplies the document in a format (e.g., PDL) that is compatible with the printer.

In one aspect, the printing component 112 accepts document finishing option instructions from the UI 104 in response to opening software applications 118 associated with the files 119. Then, the printing component 112 transmits document processing instructions to a printer 102 in response to the selected finishing options. In another aspect, the printing component 112 correlates finishing options to printer capabilities, and distributes documents 116 to printers 102 in response to correlating the document finishing options to printer capabilities. Some examples of document finishing options include stapling, duplex printing, color printing, collation, paper weight, paper brightness, paper size, scaling, n-up, rotation, and multiple image composition. However, this is not a complete list of options, as other document finishing options are known in the art.

In addition to simply selecting a cluster stored in memory, the printing component 112 accepts instructions from the UI 104 to create one or more user-defined clusters. The printing component may also save user-defined clusters in memory 113, access user-defined cluster from memory 113, or edit user-defined clusters.

The printing component 112 automatically distributes the documents using any one of a number of well-known algorithms. For example, printers may be selected on the basis round-robin scheduling or printer capability. Load-balance scheduling is an algorithm that attempts to evenly distribute document across the printers, to minimize the length (time duration) of the overall job. Alternately, printers may be selected as a result of correlating finishing options to printer capabilities. In another aspect, printer selections are made on the basis of resource monitoring (e.g., ink and paper). Other algorithms may combine some of the above-mentioned methods. For example, a combination of load-balancing and finishing option-printer capability correlation may be used as the basis of printer selection.

Alternately considered, the printing component 112 may distribute documents to printers in response to printer capabilities, where the capabilities include features such as print speed, color inks, a collator, a stapler, duplex printing, buffer memory size, multiple input paper trays, multiple output paper trays, operational status, availability, and distance from the client terminal. Operation status refers to printer “health”, and concerns whether the printer connected, turned on, and reporting no faults. Availability refers to the queue of jobs to be performed at a printer.

### Functional Description

As noted above, the printing component is a software application for printing, complete with a GUI. This application initiates the concurrent printing of a set of documents without having to open each document's native application. In addition, the printing component application extends the group printing functionality to automatically select different printers for each of the documents, thereby achieving the concurrent printing of the documents.

The invention may use services already existing in operating systems, such as Microsoft and Apple, in a new and innovative way, by adding control and user selection features. That is, control of the queuing and printer assignments can be based on simple directives from the user. Furthermore, intelligent choices can be made when choosing a printer for each specific document, based upon the finishing options selected by the user.

FIG. 2 is a diagram depicting the selection of files from an OS browser, and the selection of printers in the user-defined cluster. The Windows™ operating systems, for example, permits a user to open a directory using a browser, highlight individual files of interest, and then make a single call to the printer driver. In one aspect, the user-defined cluster printing component can use the same operating system service to compile a list of documents to be printed.

Conventionally, a user can use such a browser to highlight one or more of the files, then ‘right click’ and choose print. The operating system service opens each application in turn and, using the default printer and settings, has the document printed. However, the selection of a single printer and a common set of finishing options is defined for all the documents at the same time. The present invention printing component permits the user to choose a set of printers and, furthermore, to specify different finishing options for each document being printed. As an alternative to using the operating system service for browsing the file system, the present invention printing component may be enabled with custom software for tracing through the file system to locate each of the several documents to be printed concurrently.

Also, the printing component may be used to compile the list of printers identified by the user as most convenient. The two lists (cluster and file set) together can then be used by the software to send each document to the most convenient printer according to automated algorithms and selection criteria. The user can save the compiled list of printers so that a new list need not be compiled each time a set of documents is to be printed. The user can dynamically select the set of printers to use. These printers are typically the set closest to where the user is physically located. Different users may have different sets of printers defined as their personal cluster. The same physical printer can be in different clusters with no limit to the number of clusters or the number of times that a printer appears in different clusters.

FIG. 3 is a diagram depicting the selection of finishing options for each document. The figure also depicts the printers in the user-defined printer cluster. The printing component provides the user with the ability to select finishing and printing options individually for each document being printed, without having to open the document's native application.

The printing component or printing application permits the selection of a subset of printers convenient to the user and chosen from the entire set of printers available on the network. The printer list (user-defined cluster) may be saved for immediate or future use. The list may also be edited, as necessary. The user-defined subset of printers represents the printers that will be used to print all the documents, and it may be created through the same GUI. After identifying the list of documents to be concurrently printed, the printing component permits the user to select printing defaults, or specify printing and finishing options specific to each document, rather than be restricted to a single set of options for all the documents. Each document is automatically assigned to a printer based on algorithms specific to the configuration and dynamic status of each of the printers.

In order to start a print job, the printing component selects a document, and opens the application that created the document, if necessary. Then, the print job is directed to the correct printer. The application used to create the document does not have to be manually opened by the user. In the same session, or in subsequent sessions, the user can use the printing component to open the standard windows browser, utilizing an operating system service or custom code. Each document selected for printing may have printing options associated with it, see FIGS. 2 and 3. The user can select any, or all of the printing and finishing options available in the list of chosen printers. The user may also choose to use customized defaults by not checking any of the options.

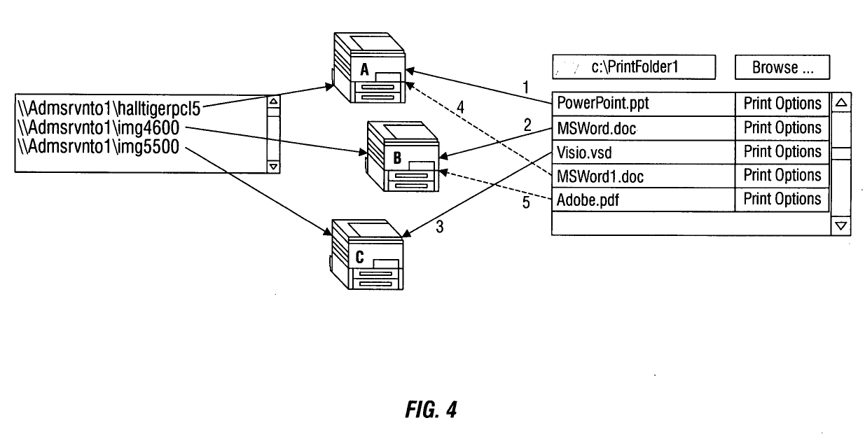

FIG. 4 is a diagram depicting the automatic assignment of documents to printers. The printing component processes the list of documents, printing each document in turn, using the print options specified for each document being printed, after automatically assigning documents to different printers. As shown in the figure, five documents are to be printed. The first document is assigned to printer A, the second to printer B, the third to printer C, the fourth queued behind the first document for printer A, and the fifth document queued behind the second document for printer B.

For simplicity, the printing component may base assignment decisions on the assumption that all printers have the same configuration. Alternatively, the printing component may use the knowledge of the options chosen for each specific document to assign the print job to the first available printer having the capability of supporting the selected options. For example, if the printing component has knowledge of the finishing options available on each printer (this information is typically available through an operating system service), then the software may choose from the set of printers best suited to print a specific document. For example, a document to be printed in duplex format would only go to a printer capable of printing on both sides of a physical medium page.

The choice of printer that is assigned to a specific document may be implemented using any of a number of scheduling algorithms. The following is an incomplete list of examples of printer selection algorithms that might be implemented:

1. Assign the first document to the first printer in the user-defined cluster list, the second document to the second printer on the list, etc. That is, use a simple ‘round-robin’ scheduling.

2. By reviewing the print queues of each of the printers, the software can make a determination of the printer most likely to be available first, and assign the next document in its print queue to that printer. This is an example of simple ‘load-balancing’ scheduling.

3. Analyze the print options associated with the document and determine the printer best able to efficiently print the document based on matching the document print options with the printer configurations. For example, if the document is to be printed on both sides of the paper, choose the printer that has a hardware duplexer, thereby, eliminating the additional software processing and manual intervention that would be required to print duplex on a printer without a hardware duplex feature.

4. Another algorithm may be based upon color printing. In the case of a monochrome document, the software might choose the next available monochrome printer in the set, saving the color printer for other documents in the set to be printed.

5. A combination of 2 and 3 above.

6. More sophisticated algorithms can be chosen to further improve load balancing and printing throughput. These algorithms would rely on looking at the static configurations of each printer, and dynamically querying their job queues, ink storage, paper, and other resources.

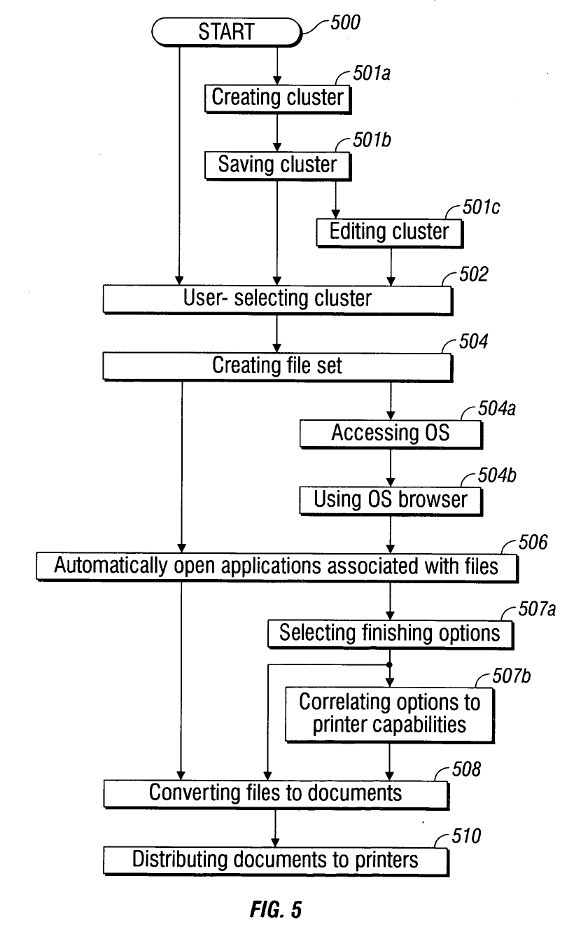

FIG. 5 is a flowchart illustrating a method for user-defined cluster printing in a client terminal network connected to a plurality of printers. Although the method is depicted as a sequence of numbered steps for clarity, the numbering does not necessarily dictate the order of the steps. It should be understood that some of these steps may be skipped, performed in parallel, or performed without the requirement of maintaining a strict order of sequence. The method starts at Step 500.

At a client terminal, Step 502 user-selects a cluster, where each cluster includes a plurality of printers network-connected to the client terminal. Step 504 creates a file set to be printed, where the file set includes a plurality of files. Step 506 automatically opens (native) software applications associated with each file in the file set. Step 508 converts each file into a printer-ready formatted document. Step 510 automatically distributes documents to printers in the selected cluster for concurrent printing.

In one aspect, creating the file set in Step 504 includes substeps. Step 504a accesses a client terminal operating system (OS). Step 504b uses an OS browser to select files from a client terminal file system directory. Then, in Step 508 the OS calls the application that created the selected file to perform the file conversion.

In another aspect, automatically distributing documents to printers in the selected cluster in Step 510 includes distributing a first document to a first printer. Step 508 converts the first file into a document format compatible with the first printer.

One aspect of the method includes an additional step. In response to automatically opening software applications associated with each file, Step 507a selects document finishing options. Then, Step 510 transmits document processing instructions to a printer in response to the selected finishing options. Further, Step 507b may correlate finishing options to printer capabilities. Then, Step 510 distributes documents to printers in response to correlating the document finishing options to printer capabilities. Some examples of finishing options include stapling, duplex printing, color printing, collation, paper weight, paper brightness, paper size, scaling, n-up, rotation, and multiple image composition.

In another aspect, Step 501a creates a user-defined cluster, and Step 501b saves the user-defined cluster in memory. Subsequent to creating the user-defined cluster, Step 501c may edit the cluster. In this aspect, user-selecting the cluster (Step 502) includes selecting the user-defined cluster in memory.

In another aspect, distributing the documents to the printers in the selected cluster (Step 510) includes distributing the documents using an algorithm such as round-robin scheduling, printer capability, load-balance scheduling, finishing option-printer capability correlation, a combination of load-balancing and finishing option-printer capability correlation, or printer resource monitoring.

Step 510 may distribute the documents to the printers in response to printer capabilities, where the capabilities include features such as print speed, color inks, a collator, a stapler, duplex printing, buffer memory size, multiple input paper trays, multiple output paper trays, operational status, availability, and distance from the client terminal.

A system and method has been provided for printing a set of documents with a user-defined printer cluster. Some examples of formats and distributions algorithms have been given to illustrate the invention. However, the invention is not limited to merely these examples. Other variations and embodiments of the invention will occur to those skilled in the art.

We claim:

1. In a client terminal network connected to a plurality of printers, a method for user-defined cluster printing, the method comprising;
at a client terminal, user-selecting a cluster, where each cluster includes a plurality of printers network-connected to the client terminal;
creating a file set to be printed, where the file set includes a plurality of files; and,
automatically distributing documents to printers in the selected cluster for concurrent printing.

2. The method of claim 1 further comprising:
automatically opening software applications associated with each file in the file set; and,
converting each file into a printer-ready formatted document.

3. The method of claim 2 wherein creating the file set includes:
accessing a client terminal operating system (OS);
using an OS browser to select files from a client terminal file system directory; and,
wherein converting each file into a printer-ready formatted document includes the OS calling an application that created the selected file to perform the file conversion.

4. The method of claim 2 wherein automatically distributing documents to printers in the selected cluster includes distributing a first document to a first printer; and,
wherein converting each file into a printer-ready formatted document includes converting the first file into a document format compatible with the first printer.

5. The method of claim 2 further comprising:
in response to automatically opening software applications associated with each file, selecting document finishing options; and,
wherein distributing the documents to the printers in the selected cluster includes transmitting document processing instructions to a printer in response to the selected finishing options.

6. The method of claim 5 further comprising:
correlating finishing options to printer capabilities; and,
wherein distributing the documents to the printers in the selected cluster includes distributing documents to printers in response to correlating the document finishing options to printer capabilities.

7. The method of claim 5 wherein selecting document finishing options includes selecting options from a group consisting of stapling, duplex printing, color printing, collation, paper weight, paper brightness, paper size, scaling, n-up, rotation, and multiple image composition.

8. The method of claim 1 further comprising:
creating a user-defined cluster;
saving the user-defined cluster in memory; and,
wherein user-selecting the cluster includes selecting the user-defined cluster in memory.

9. The method of claim 8 further comprising:
subsequent to creating the user-defined cluster, editing the cluster.

10. The method of claim 1 wherein distributing the documents to the printers in the selected cluster includes distributing the documents using an algorithm selected from a group consisting of round-robin scheduling, printer capability, load-balance scheduling, finishing option-printer capability correlation, a combination of load-balancing and finishing option-printer capability correlation, and printer resource monitoring.

11. The method of claim 1 wherein distributing the documents to the printers in the selected cluster includes distributing the documents to printers in response to printer capabilities, where the capabilities are selected from a group consisting of print speed, color inks, a collator, a stapler, duplex printing, buffer memory size, multiple input paper trays, multiple output paper trays, operational status, availability, and distance from the client terminal.

12. In a client terminal network connected to a plurality of printers, a system for user-defined cluster printing, the system comprising;
a client terminal user interface (UI);
a client terminal network interface connected to a plurality of printers; and,
a user-defined cluster printing component stored as software coded instructions in a client terminal memory, the printing component communicating with the UI to accept cluster selections, where each cluster includes a plurality of network-connected printers, and accept instructions for creating a file set including a plurality of files to be printed, the printing component automatically distributing documents to printers in the selected cluster, via the network interface, for concurrent printing.

13. The system of claim 12 wherein the printing component automatically initiates the opening of software applications associated with each file in the file set, to convert each file into a printer-ready formatted document.

14. The system of claim 13 further comprising:
a file system represented as a directory of files stored in memory;
an operating system (OS) stored as microprocessor instructions in a client terminal memory;
wherein the printing component accesses an OS browser to select files from the file system directory; and,
wherein the OS calls an application that created the selected file to convert files into printer-ready formatted documents.

15. The system of claim 13 wherein the printing component selects a first printer and distributes a first document to the first printer; and,
wherein the printing component supplies the first document in a format compatible with the first printer.

16. The system of claim 13 wherein the printing component accepts document finishing option instructions from the UI in response to opening software applications associated with the files, and transmits document processing instructions to a printer in response to the selected finishing options.

17. The system of claim 16 wherein the printing component correlates finishing options to printer capabilities, and distributes documents to printers in response to correlating the document finishing options to printer capabilities.

18. The system of claim 16 wherein the printing component accepts document finishing option instructions form the UI selected from a group consisting of stapling, duplex printing, color printing, collation, paper weight, paper brightness, paper size, scaling, n-up, rotation, and multiple image composition.

19. The system of claim 12 wherein the printing component accepts instructions from the UI and performs an operation selected from a group consisting of creating a user-defined cluster, saving a user-defined cluster in memory, accessing a user-defined cluster from memory, and editing a user-defined cluster.

20. The system of claim 12 wherein the printing component distributes the documents using an algorithm selected from a group consisting of round-robin scheduling, printer capability, load-balance scheduling, finishing option-printer capability correlation, a combination of load-balancing and finishing option-printer capability correlation, and printer resource monitoring.

21. The system of claim 12 wherein the printing component distributes the documents to printers in response to printer capabilities, where the capabilities are selected from a group consisting of print speed, color inks, a collator, a stapler, duplex printing, buffer memory size, multiple input paper trays, multiple output paper trays, operational status, availability, and distance from the client terminal.
